(19) United States
(12) Patent Application Publication
(10) Pub. No.: US 2017/0307804 A1
(43) Pub. Date: Oct. 26, 2017

(54) Luminaire

(71) Applicant: Christopher Michael Bryant, Social Circle, GA (US)

(72) Inventor: Christopher Michael Bryant, Social Circle, GA (US)

(21) Appl. No.: 14/925,822

(22) Filed: Oct. 28, 2015

Related U.S. Application Data
(60) Provisional application No. 62/072,228, filed on Oct. 29, 2014.

(51) Int. Cl. F21V 8/00; F21S 8/04

(52) U.S. Cl. CPC G02B 6/0055; F21S 8/043; G02B 6/0068

(57) ABSTRACT

A luminaire can comprise at a light source, a lightguide, and a reflective surface. The lightguide can comprise two major surfaces, for example two faces of a panel of optical material. The light source can couple light into the lightguide through an edge of the lightguide. The coupled light can exit the lightguide through the major faces of the lightguide. The reflective surface can be oriented to receive and redirect the light emitted from the lightguide. Via this redirection, the luminaire can emit illumination in direction that is different from the light source's emissions. For example, the light source can emit light upward and into the lightguide, the lightguide can emit and distribute that light outward, and the reflective surface can redirect the light downward.

### CROSS REFERENCE TO RELATED APPLICATIONS

This application claims priority to U.S. Provisional Patent Application No. 62/072,228 filed Oct. 29, 2014 in the name of Christopher Michael Bryant and entitled “Luminaire,” the entire contents of which are hereby incorporated herein by reference.

### TECHNICAL FIELD

Embodiments of the technology relate generally to a lighting apparatus that includes a panel-shaped lightguide, and more particularly to a luminaire configuration in which light emitting diodes couple light into a lower edge of the lightguide.

### BACKGROUND

For illumination applications, light emitting diodes (LEDs) offer substantial potential benefit associated with their energy efficiency, light quality, and compact size. However, to realize the full potential benefits offered by light emitting diodes, new technologies are needed. For instance, relative to incandescent lights, light emitting diodes typically emit light in different patterns or formats.

Accordingly, there are needs in the art for technology to manage illumination produced by one or more light emitting diodes. Need exists for technology to produce illumination with desirable characteristics, for example by spreading or distributing the light output of one or more light emitting diodes. Need further exists for technology to produce illumination via redirecting light output from one or more light emitting diodes. A capability addressing one or more such needs, or some other related deficiency in the art, would support improved illumination systems and more widespread utilization of light emitting diodes in lighting applications.

### SUMMARY

A luminaire can comprise a light source positioned adjacent an edge of a lightguide that is panel-shaped. The light source can couple light into the lightguide through the edge. The coupled light can exit the lightguide through the major faces of the lightguide. The luminaire can comprise at least one reflective surface that is oriented to receive and redirect the light emitted from the lightguide. Via this redirection, the luminaire can emit illumination in a different or opposing direction from the light source's emissions. For example, the light source can emit light upward and into the lightguide, the lightguide can emit and distribute that light outward, and the reflective surface can redirect the light downward.

The foregoing discussion is for illustrative purposes only. Various aspects of the present technology may be more clearly understood and appreciated from a review of the following text and by reference to the associated drawings and the claims that follow. Other aspects, systems, methods, features, advantages, and objects of the present technology will become apparent to one with skill in the art upon examination of the following drawings and text. It is intended that all such aspects, systems, methods, features, advantages, and objects are to be included within this description and covered by this application and by the appended claims of the application.

### BRIEF DESCRIPTION OF THE FIGURES

Reference will be made below to the accompanying drawings.

FIGS. 1A, 1B, 1C, and 1D (collectively FIG. 1) illustrate four perspective views of an example overhead luminaire according to some embodiments of the disclosure.

FIGS. 2A, 2B, and 2C (collectively FIG. 2) provide representative assembly views for the example luminaire according to some embodiments of the disclosure.

FIGS. 3A and 3B (collectively FIG. 3) illustrate an example lightguide of the luminaire according to some embodiments of the disclosure.

FIGS. 4A and 4B (collectively FIG. 4) illustrate an example channel of the luminaire that extends along an edge of the lightguide according to some embodiments of the disclosure.

The drawings illustrate only example embodiments and are therefore not to be considered limiting of the embodiments described, as other equally effective embodiments are within the scope and spirit of this disclosure. The elements and features shown in the drawings are not necessarily drawn to scale, emphasis instead being placed upon clearly illustrating principles of the embodiments. Additionally, certain dimensions or positionings may be exaggerated to help visually convey certain principles. In the drawings, similar reference numerals among different figures designate like or corresponding, but not necessarily identical, elements.

### DETAILED DESCRIPTION OF EXAMPLE EMBODIMENTS

A luminaire can incorporate a lightguide to facilitate light distribution. The lightguide can have a panel or slab shape and can be mounted vertically so that the lightguide has a lower edge and an upper edge. Light can be introduced into the lightguide from the lower edge, so that the major faces of the lightguide internally reflect and guide the light upward, towards the upper edge. A portion of the internally propagating light that is incident on each face can exit the lightguide through each face so that the faces gradually distribute light. One or more diffuse reflectors that are mounted near the lightguide can redirect downward the light that exits the faces of the lightguide, thereby providing overhead illumination. Coupling light into the lightguide in one direction and configuring the luminaire to emit illumination in a differing or opposing direction can improve illumination quality, for example by suppressing glare and/or avoiding visual hotspots.

Some representative embodiments will be described more fully hereinafter with example reference to the accompanying drawings that illustrate embodiments of the technology. The technology may, however, be embodied in many different forms and should not be construed as limited to the embodiments set forth herein; rather, these embodiments are provided so that this disclosure will be thorough and complete, and will fully convey the scope of the technology to those appropriately skilled in the art.

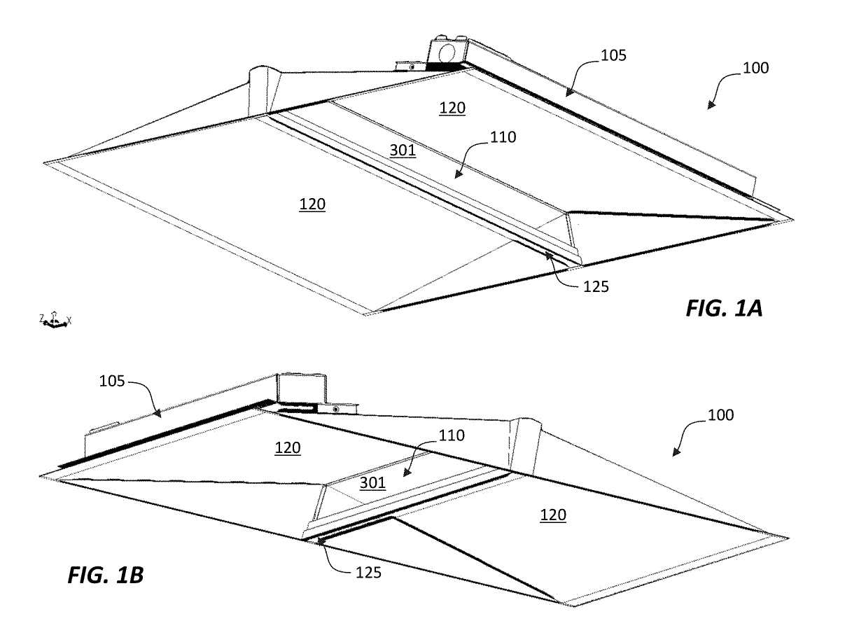

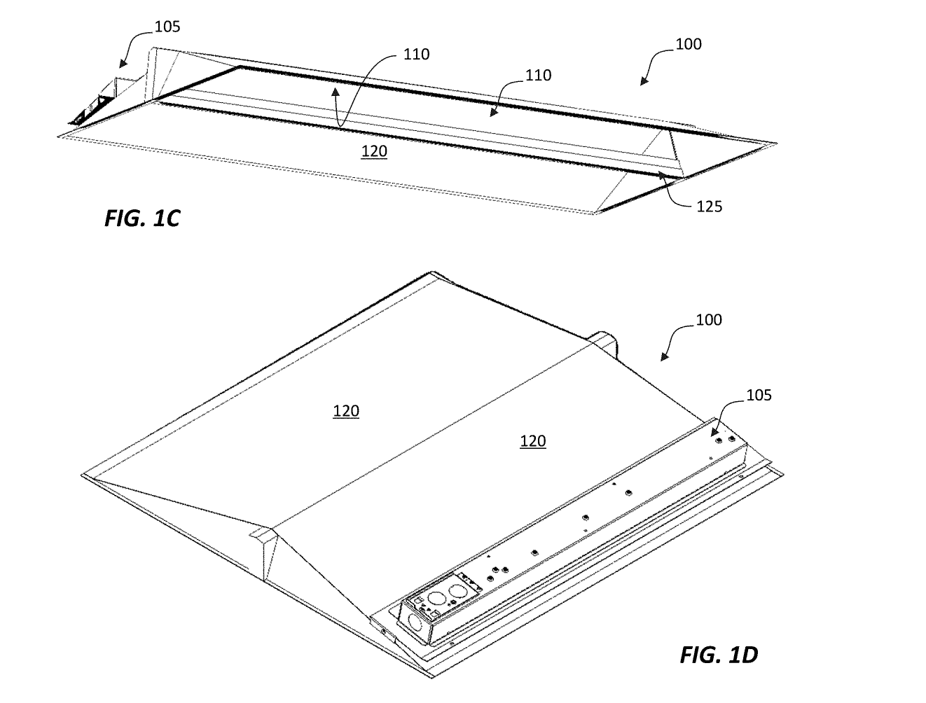

FIGS. 1A, 1B, 1C, and 1D illustrate four perspective views of an overhead luminaire 100 according to some example embodiments of the disclosure. FIGS. 1A, 1B, and 1C show the light-emitting side of the luminaire 100, which can be mounted in a drop-in ceiling installation, for example. FIG. 1D shows the upper side of the luminaire 100.

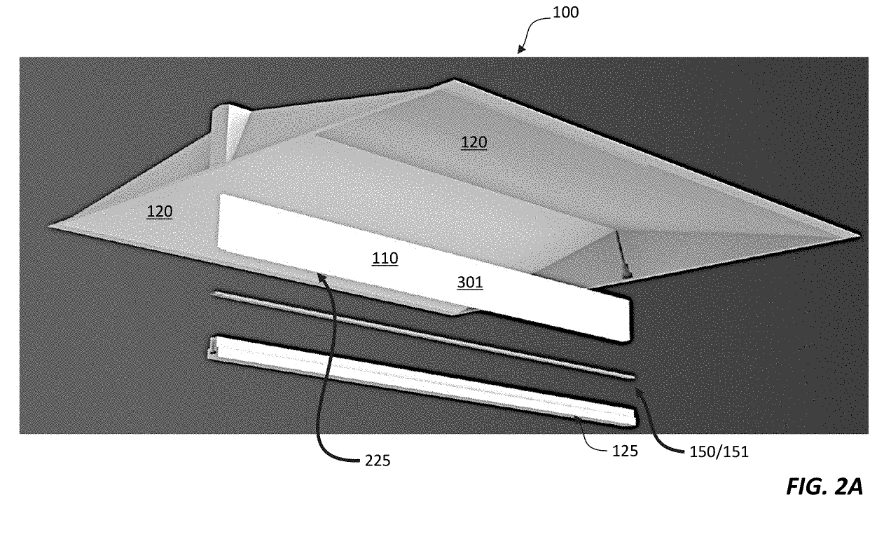

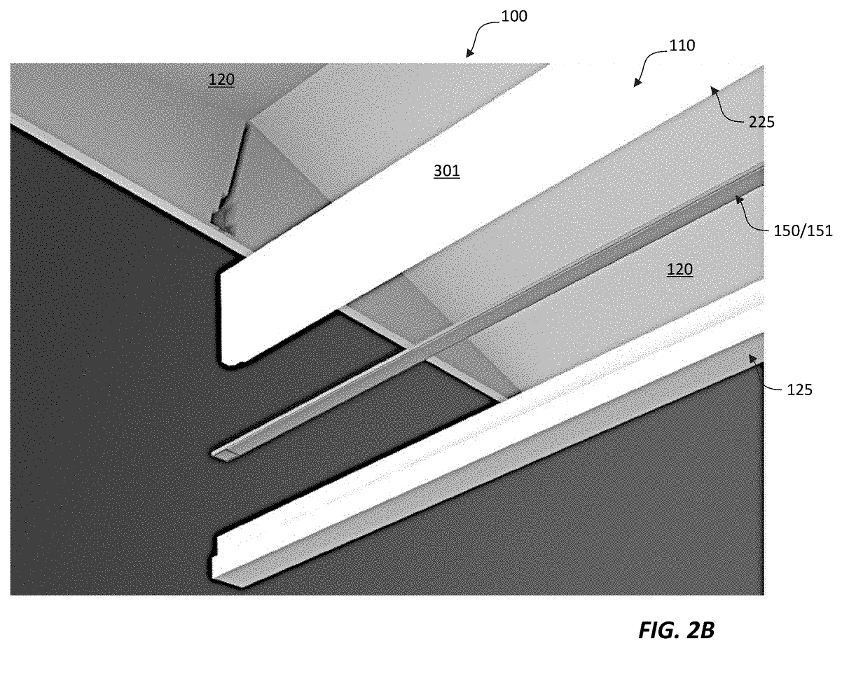

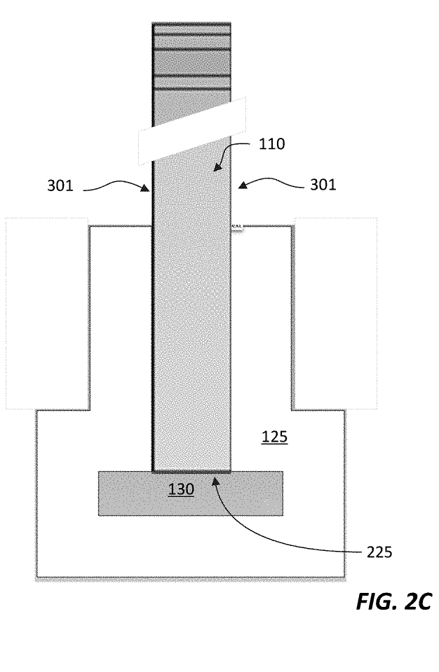

FIGS. 2A, 2B, and 2C provide representative assembly views for the luminaire 100 according to some example embodiments of the disclosure. FIGS. 2A and 2B illustrate exploded views of the luminaire 100, while FIG. 2C illustrates a cross sectional detail view of the luminaire 100.

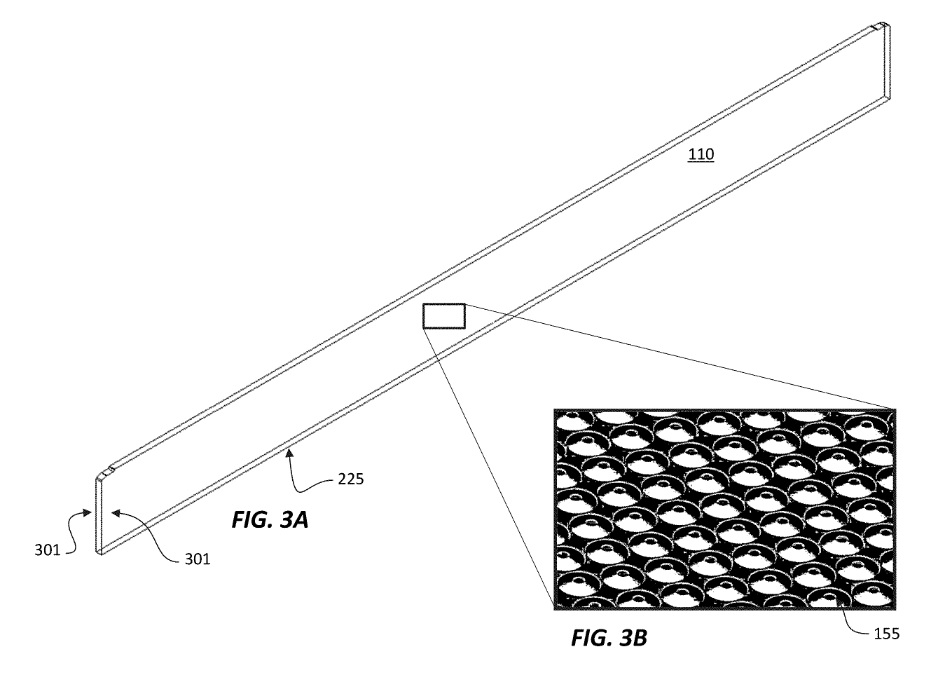

FIGS. 3A and 3B illustrate a lightguide 110 of the luminaire 100 according to some example embodiments of the disclosure. FIG. 3A illustrates an overall view, while FIG. 3B illustrates a magnified view showing example surface features.

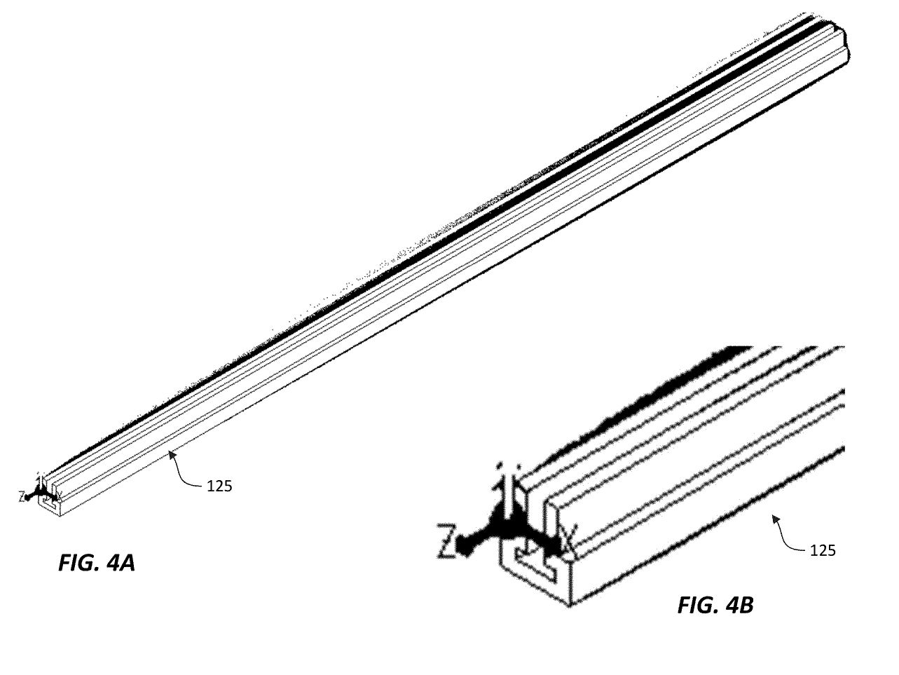

FIGS. 4A and 4B illustrate a channel 125 of the luminaire 100 that extends along an edge of the lightguide 110 according to some example embodiments of the disclosure. FIG. 4A illustrates an overall view, while FIG. 4B illustrates a magnified view.

Referring now collectively to FIGS. 1-4, some example embodiments will be discussed in further detail. As best seen in FIG. 1, the illustrated luminaire 100 is configured for overhead mounting, for example in a suspended or drop-in ceiling application. In this orientation, the luminaire 100 emits illumination downward and into a room or other space. Other embodiments may be configured for installation outdoors or for mounting to a wall or other suitable structure. Some other example embodiments may be utilized in portable or handheld applications.

In the illustrated embodiment, the lightguide 110 of the luminaire 100 extends horizontally and vertically. More specifically, the lightguide 110 is mounted in the luminaire 100 so that the major faces 301 of the lightguide 110 have a substantially vertical orientation when the luminaire 100 is installed. As will be discussed in further detail below, the lightguide 100 emits light through the major faces 301, and the luminaire 100 directs that light generally downward to provide illumination.

The channel 125 extends along a lower edge 225 of the lightguide 110 and forms a cavity 130 that is visible in the cross sectional view of FIG. 2C. As shown in the exploded views of FIGS. 2B and 2C, a light source 150 extends along the lower edge 225 of the lightguide 110 in the cavity 130.

In some example embodiments, the light source 150 is held in the cavity 130 with adhesive or glue. In some example embodiments, the light source 150 is held in the cavity 130 with screws or other fasteners. In some example embodiments, the light source 150 is held in the cavity 130 with one or more mounts or brackets. In some example embodiments, friction or interference holds or retains the light source 150 in the cavity 130.

In an example embodiment, the light source 150 comprises an array of light emitting diodes 151. The light source 150 can comprise a circuit board to which the light emitting diodes 151 are mounted, for example.

In operation, the light emitting diodes 151 emit light through the lower edge 225 of the lightguide 110. Each light emitting diode 151 thus couples light into the lightguide 110 through the lower edge 225. The major faces 301 of the lightguide 110 guide the coupled light upward, typically via total internal reflection with a controlled release of light as further discussed below.

As will be discussed below with reference to FIG. 3, one or both of the major faces 301 is typically patterned with microlenses 155 (see FIG. 3B) that help release the guided light from the lightguide 110 in a controlled fashion. In some example embodiments, the features may be located within one or more defined surface areas of the lightguide 110, rather than fully covering the major faces 301 of the lightguide 110. Such an area may be viewed as an extraction surface or region in some embodiments.

In some example embodiments, the channel 125 provides a heat sink for the light emitting diodes. To facilitate heat transfer, the channel 125 can comprise aluminum or other metal or a thermally conductive plastic material, for example.

In some example embodiments, machining a bar of aluminum or other appropriate metal forms the channel 125. In some example embodiment, welding, fusing, or otherwise joining two or more strips or bars of aluminum or other appropriate metal forms the channel 125. In some example embodiments, fabrication of the channel 125 comprises extruding aluminum. For example, the channel 125 can be fabricated in a continuous or semi-continuous process in which the channel 125 feeds out of a metal production machine.

In addition to thermal management, the channel 125 physically supports the circuit board so that the light emitting diodes 151 are positioned against the lower lightguide edge 225. The channel 125 can further protect the circuit board of the light source 150 and obscure the light source 151 and circuit board from view.

In some example embodiments, the channel 125 further provides a mixing chamber so that light emitted from discrete light emitting diodes 151 can mix prior to emerging from the shielded area. Thus, the channel 125 can help eliminate hot spots that might otherwise be visible to an observer in an area receiving illumination from the luminaire 100, for example a person walking under the luminaire 100 in a room. Accordingly, the channel 125 can provide a volume or area in which light from individual light emitting diodes 151 mixes and blends to provide a uniform or even distribution, which observers may perceive as desirable.

In some example embodiments, the channel 125 is glued to the lightguide 110. In some example embodiments, the channel 125 is fused to the lightguide 110. In some example embodiments, screws or other fasteners hold the channel 125 to the lightguide 110. In some example embodiments, interference or a friction fit holds the channel 125 to the lightguide 110.

In the illustrated embodiment, the lightguide 110 is generally rectangular. Other example embodiments may have a shape or outline that is triangular, octagonal, oval, oblong, square, hexagonal, circular, polygon, or other appropriate form. In some embodiments, the lightguide 100 can comprise a combination of straight and curved edges. Embodiments of the lightguide 110 can be made by cutting or molding a plate, slab, or panel of optical material and polishing the edges to an optical finish. Various other appropriate fabrication techniques may alternatively be utilized. The lightguide 110 can comprise a slab, plate, or panel formed of acrylic or another appropriate optical material, for example. Cutting or molding a plate, slab, or panel of optical material into an appropriate shape can yield various lightguide forms, for example.

As illustrated in the detail inset of FIG. 3B, one or both of the major faces 301 of the lightguide 110 is typically patterned with microlenses 155 that help release the guided light from the lightguide 100 in a controlled fashion. The microlenses 155 can comprise conical features, truncated cones, convex shapes, holes, concave structures, dimples, or other appropriate micro-optical features, for example.

In some example embodiments, the lightguide 110 comprises one or more of the technologies disclosed in U.S. Pat. No. 8,459,858, the entire contents of which are hereby incorporated herein by reference. In some example embodiments, the lightguide 110 comprises one or more of the technologies disclosed in U.S. Pat. No. 7,357,553, the entire contents of which are hereby incorporated herein by reference.

Two reflective surfaces 120 of the luminaire 100 receive and redirect light emitted from the major faces 301 of the lightguide 110. As illustrated, the reflective surfaces 120 are slanted to rise above and converge towards the upper edge of the lightguide 110. The reflective surfaces 120 can form a vertex or apex, for example. In this orientation, the reflective surfaces 120 direct the lightguide-emitted light downward, towards an area to be illuminated.

As illustrated in FIGS. 1A, 1B, 1C, and 1D a power supply 105 and associated housing is mounted to the upper side of the luminaire frame. The power supply 105 typically receives line electricity and emits electricity formatted to drive the light emitting diodes 151. The power supply 105 can comprise a light emitting diode driver, for example. In an example embodiment, the power supply 105 can convert alternating current from line power into direct or pulsed current suitable for supplying to the light emitting diodes 151 and causing the light emitting diodes 151 to emit light useful for illumination in a luminaire or lighting fixture.

Illumination technology has been described. Many modifications and other embodiments of the disclosures set forth herein will come to mind to one skilled in the art to which these disclosures pertain having the benefit of the teachings presented in the foregoing descriptions and the associated drawings. Therefore, it is to be understood that the disclosures are not to be limited to the specific embodiments disclosed and that modifications and other embodiments are intended to be included within the scope of this application. Although specific terms are employed herein, they are used in a generic and descriptive sense only and not for purposes of limitation.

What is claimed is:

1. A lighting system comprising:
a light emitting diode oriented to emit light in a first direction; and
a lightguide comprising:
a first face;
a second face opposite the first face; and
an edge that extends between the first face and the second face and that is disposed adjacent the light emitting diode to receive the emitted light so that received light exits the lightguide through the first face and the second face; and
one or more reflectors oriented to produce a pattern of illumination emitted from the lighting system in a second direction that opposes the first direction.

2. The lighting system of claim 1, wherein an array of light emitting diodes comprises the light emitting diode, the array disposed adjacent the edge of the lightguide.

3. The lighting system of claim 1, wherein the lightguide comprises an optical material disposed between the first face and the second face.

4. The lighting system of claim 1, wherein the first direction comprises up and the second direction comprises down.

5. The lighting system of claim 1, wherein the lightguide is mounted vertical in the lighting system.

6. The lighting system of claim 1, wherein at least one of the first face and the second face is patterned to release light out of the lightguide.

7. The lighting system of claim 1, wherein the lighting system comprises a drop-in ceiling fixture or a pendant fixture.

8. The lighting system of claim 1, wherein each of the one or more reflectors comprises a reflective surface.

9. A luminaire comprising:
a lightguide comprising:
a first internally reflective face formed on a body of optical material;
a second internally reflective face formed on the body of optical material, opposite the first internally reflective face;
an upper edge extending on the body of optical material between the first internally reflective face and the second internally reflective face; and
a lower edge extending on the body of optical material between the first internally reflective face and the second internally reflective face; and
a light source positioned adjacent the lower edge to couple light into the lightguide through the lower edge.

10. The luminaire of claim 9, further comprising a reflector positioned to redirect downward light emitted through one or more of the first internally reflective face and the second internally reflective face.

11. The luminaire of claim 9, further comprising:
a first reflective surface oriented to redirect downward light emitted through the first internally reflective face of the lightguide; and
a second reflective surface oriented to redirect downward light emitted through the second internally reflective face of the lightguide.

12. The luminaire of claim 9, wherein the first and second internally reflective faces are patterned to regulate light transmission through the first and second internally reflective faces.

13. The lightguide of claim 9, wherein the lightguide comprises an edgelit panel.

14. The lightguide of claim 9, wherein the optical material comprises a substantially clear material; and
wherein the first face comprises a polygon.

15. The lightguide of claim 14, wherein the substantially clear materials comprises plastic, glass, or silicone.

16. The lightguide of claim 9, wherein the first internally reflective face lies along a plane.

17. A lighting system comprising:
a light source that is operative to emit light along an axis that extends upward from the light source;
a panel of optical material that forms a lightguide and that comprises:
a first face;
a second face opposite the first face;
a lower edge that extends between the first face and the second face and that is disposed adjacent the light source to receive the emitted light;
an upper edge that extends between the first face and the second face, opposite the lower edge,
wherein the axis extends into the panel through the lower edge, extends within the panel between the first face and the second face, and extends out of the panel through the second edge; and
a first reflective surface facing the first face and oriented to reflect light emitted from the panel through the first face; and
a second reflective surface facing the second face and oriented to reflect light emitted from the panel through the second face,
wherein the first reflective surface and the second reflective surface approach one another above the upper edge.

18. The lighting system of claim 17, wherein the light source comprises an array of light emitting diodes that extends along the lower edge, and
wherein the first face and the second face comprise optical features for coupling light out of the lightguide.

19. The lighting system of claim 17, wherein the lighting system is configured to provide overhead illumination, and
wherein the first reflective surface and the second reflective surface approach one another above the upper edge to form an apex.

20. The lighting system of claim 17, wherein the lighting system comprises a drop-in ceiling fixture or a pendant fixture.
